(19) United States
(12) Patent Application Publication
(10) Pub. No.: US 2011/0151319 A1
(43) Pub. Date: Jun. 23, 2011

(54) SECONDARY BATTERY WITH ENHANCED STRUCTURE

(75) Inventors: Jing-Yih CHERNG, Gueishan Township (TW); Chin-Ming Chen, Gueishan Township (TW); Xin-Fa Lin, Gueishan Township (TW)

(73) Assignee: AMITA TECHNOLOGIES INC LTD.

(21) Appl. No.: 12/975,616

(22) Filed: Dec. 22, 2010

(30) Foreign Application Priority Data
Dec. 23, 2009 (TW) 098224089

(51) Int. Cl. H01M 2/02; H01M 2/10

(52) U.S. Cl. 429/177

(57) ABSTRACT

A package structure of secondary battery includes a flexible battery cell which is arranged within an accommodation space enclosed by a rigid shell; and a sealing agent which is injected into the gap between the flexible battery cell and the rigid shell. By sealing the rigid body, the secondary battery has a waterproof capability and the structural strength of the flexible battery cell is further enhanced.

### BACKGROUND OF THE INVENTION

1. Field of the Invention

The present invention in general relates to a battery, in particular, to a package structure of secondary battery.

2. Description of Prior Art

Rechargeable battery (or so-called “secondary battery”) can be recharged with electricity. When a plurality of battery units are assembled into a battery device by series or parallel connection, it can be adapted as a power source for a variety of appliances, for example, as a battery device for car or electric car.

According to prior arts, a secondary battery has a shell made of aluminum or other metals. After the components, such as cathodes, partition pieces and anodes are disposed in the sell, a sealing lid is welded thereon to seal the opening. Next, the operations of electrolyte injection and degassing are undertaken. However, since of the need of welding, this kind of battery consumes more time and labor during assembly, so the manufacturing cost is expensive. Furthermore, because of uneasiness to recover the waste, it is also environmental unfriendliness.

Nowadays, flexible package is a commonly packaging manner for another kind of secondary battery. In the assembly process of flexible battery, a plurality of components, such as, cathode, partition piece and anode, are sealed in a thin envelope; next, by passing the cathode wire and anode wire through the top side of the envelope-typed shell, a battery unit is thereby constituted. This kind of battery has excellent tightness, because of flexible package. Furthermore, due to the superior tightness, the manufacturing time and cost are reduced in a large scale. However, since of the flexible package, the thin envelope is mostly comprised of multiple layers of thin film, so the structural strength of the shell becomes the biggest problem for this kind of battery.

Accordingly, after a substantially devoted study, in cooperation with the application of relative academic principles, the inventor has finally proposed the present invention designed reasonably to possess the capability to improve the drawbacks of the prior arts significantly.

### SUMMARY OF THE INVENTION

Therefore, in order to solve aforementioned problems, the invention is mainly to provide a secondary battery with enhanced structure, such that the structural strength of a flexible battery cell is enhanced.

Secondly, the invention is to provide a secondary battery with enhanced structure, in which a sealing agent is disposed in the gap between a flexible battery cell and a rigid shell, such that the secondary battery possesses a capability of waterproof.

Thirdly, the invention is to provide a secondary battery with enhanced structure, including a rigid shell, at least one flexible battery cell and a sealing agent. The rigid shell has an accommodation space, in which the flexible battery cell is arranged, while the sealing agent is injected into the gap between the flexible battery cell and the rigid shell.

Fourthly, the invention is to provide a secondary battery with enhanced structure, a rigid shell of which is comprised of frame, panel and top plate, such that it is easy to dismantle and fulfill the requirement of environmental protection.

Compared with the prior arts, the invention has following merits. First of all, the secondary battery with enhanced structure according to the invention is to arrange the flexible battery cell in a rigid shell to enhance the structural strength thereof. Furthermore, since a sealing agent is injected into the gap between the rigid shell and the flexible battery cell, not only the rigid shell can be sealed, but also a waterproof capability is possessed. Finally, the rigid body is comprised of frame and plate, so the dismantlement and recovery are easy when discarded, enhancing the environmental friendliness and practicability of the invention.

### BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

FIG. 1 is an explosive illustration of the secondary battery with enhanced structure according to the present invention;

FIG. 2 is a perspective outer illustration of the secondary battery with enhanced structure according to the present invention;

FIG. 3 is a cross-sectional view along the line “3-3” in FIG. 2;

FIG. 4 is a cross-sectional view along the line “4-4” in FIG. 2;

FIG. 5 is a second embodiment of the secondary battery with enhanced structure according to the present invention;

FIG. 6 is a third embodiment of the secondary battery with enhanced structure according to the present invention; and

FIG. 7 is a fourth embodiment of the secondary battery with enhanced structure according to the present invention.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

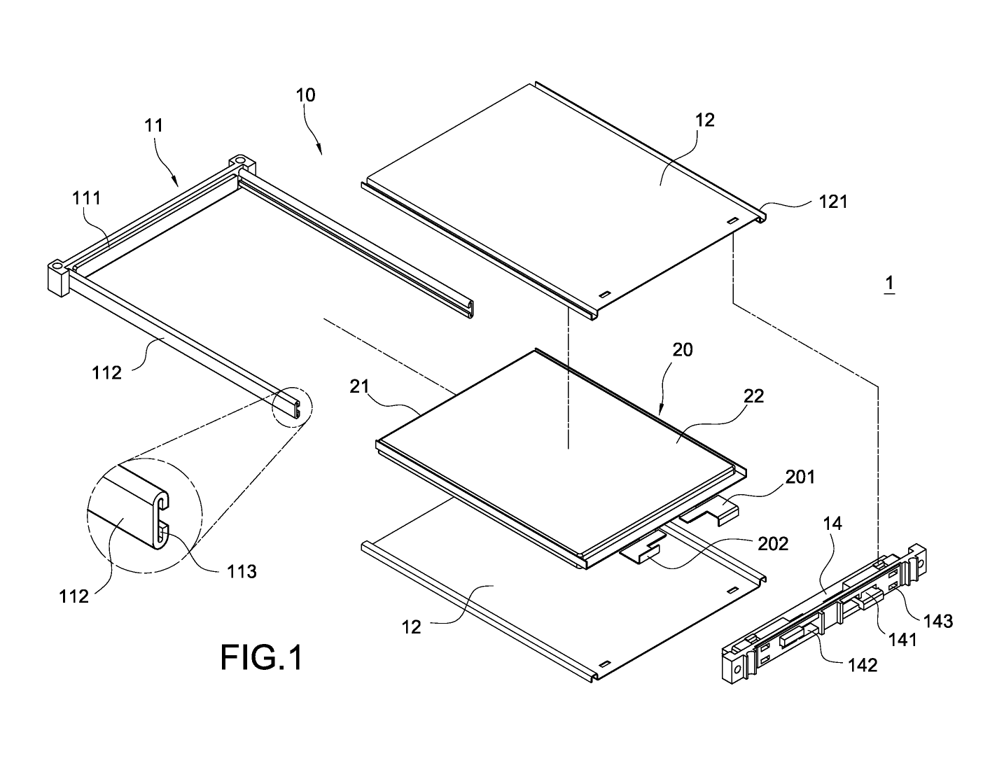

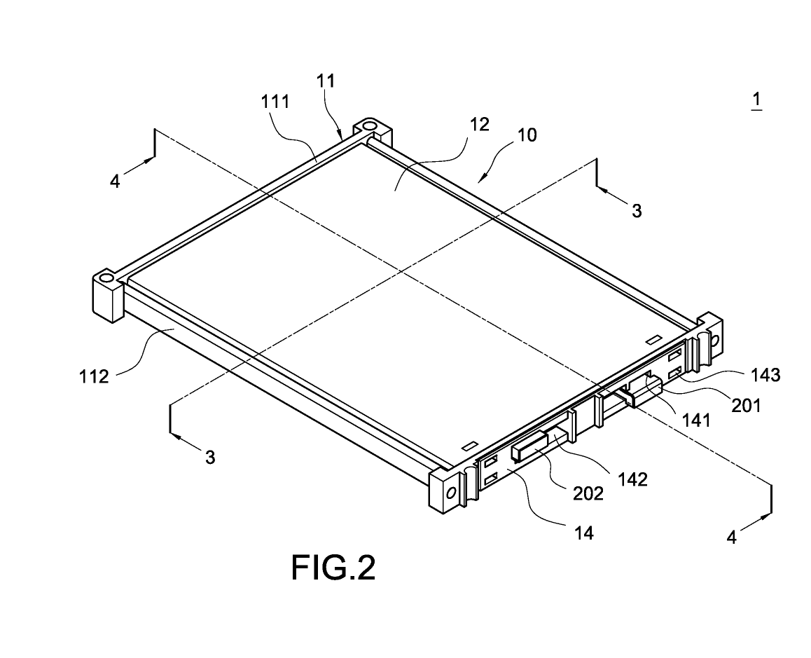

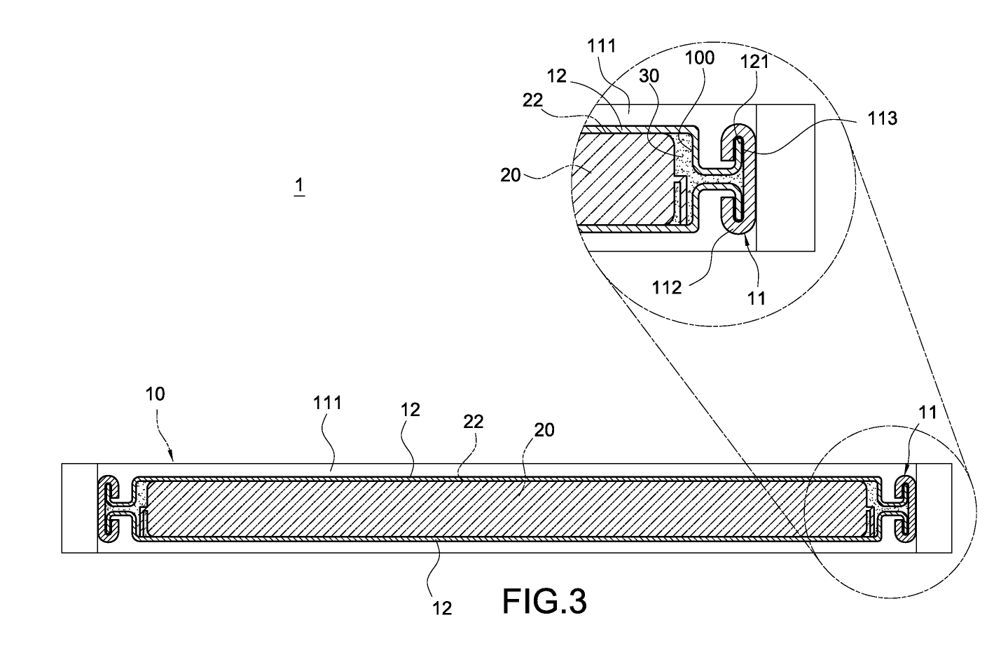

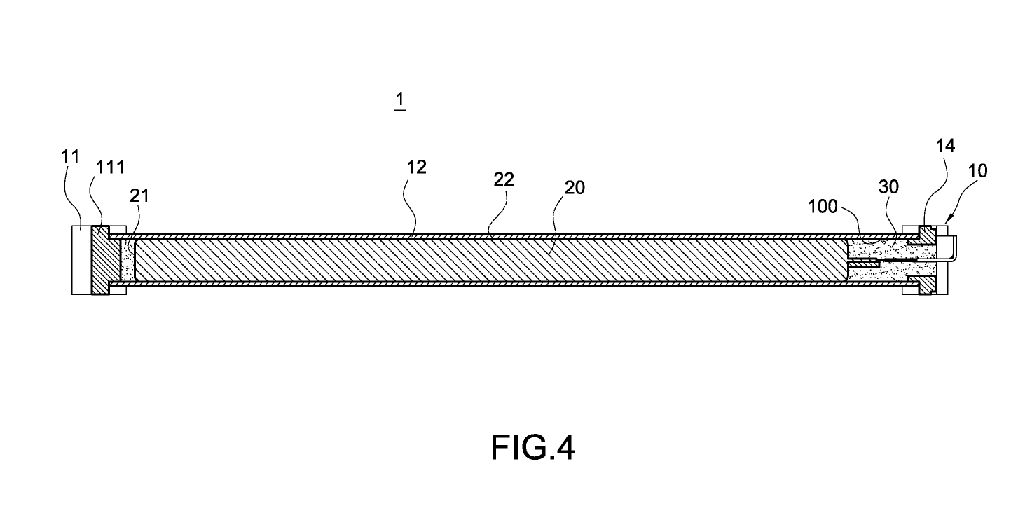

Please refer to FIG. 1 through FIG. 4, separately showing an explosive illustration, a perspective outer illustration and two cross-sectional views of the secondary battery with enhanced structure according to the present invention. The secondary battery with enhanced structure 1 according to the present invention includes a rigid shell 10, at least one flexible battery cell 20 and a sealing agent 30 injected into the gap between the rigid shell 10 and the flexible battery cell 20.

The rigid shell 10 is made of a material of metal, such as, aluminum. The rigid shell 10 has a frame 11, two panels 12 connected to the lateral sides of the frame 11 and a top plate 14 sealing and covering the frame 11 and the two panels 12, all of which enclose an accommodation space 100. In this embodiment, the frame 11 is shown as a “U” shape, including a bottom plate 111 and two lateral plates 112 extended from two lateral ends of the bottom plate 111. The cross section of the lateral plate 112 is shown as a “C” shape and configured with two grooves 113. Two lateral sides of the panel 12 are respectively configured a connection part 121 (in this embodiment, the cross section of the connection part 121 is shown as a “U” shape). The connection part 121 is inserted into the groove 113 to connect the panel 12 and the frame 11. After the rigid shell 10 is assembled, the flexible battery cell 20 is arranged in the accommodation space 100.

The flexible battery cell 20 can be a lithium-ion battery or a polymer lithium battery, having a positive terminal 201 and a negative terminal 202. The bottom face 21 of the flexible battery cell 20 is closely attached onto the bottom plate 111 of the rigid shell 10. Two surfaces 22 of the flexible battery cell 20 are opposite to each other and closely contacted with two panels 12 of the rigid shell 10. Next, the top plate 14 covers the top side of the rigid shell 10. The top plate 14 is arranged two slots 141, 142 and at least one injection hole 143. When the top plate 14 covers the rigid shell 10, the positive terminal 201 and the negative terminal 202 respectively pass through the two slots 141, 142.

After the assembly is completed according to aforementioned steps, the sealing agent 30, such as, epoxy, is injected into the rigid shell 10 from the injection hole 143 on the top plate 14, such that the sealing agent 30 is filled in the gap between the flexible battery cell 20 and the rigid shell 10, whereby the rigid shell 10 is sealed. According to the invention, the secondary battery 1 possesses the capability of waterproof. Meanwhile, the structural strength of the flexible battery cell 20 is further enhanced.

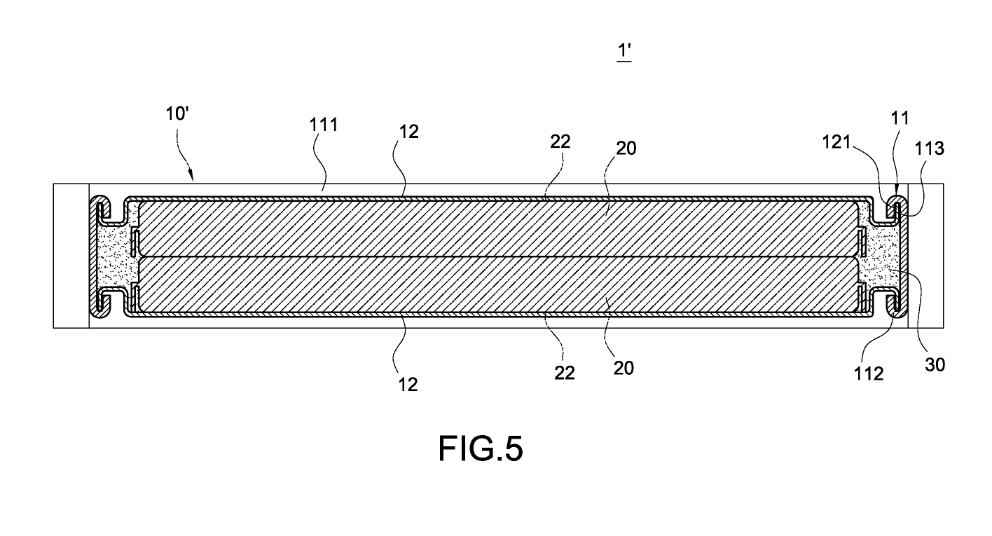

Please refer to FIG. 5, which is a secondary battery with enhanced structure according to the second embodiment of the invention. This embodiment is substantially same as the first embodiment, except that the interior of the rigid shell 10′ of the secondary battery 1′ is installed two flexible battery cells 20, the electrically connective manner of which may be in series or in parallel. In practical implementation, the quantity of the flexible battery cell 20 can be increased according to usage need.

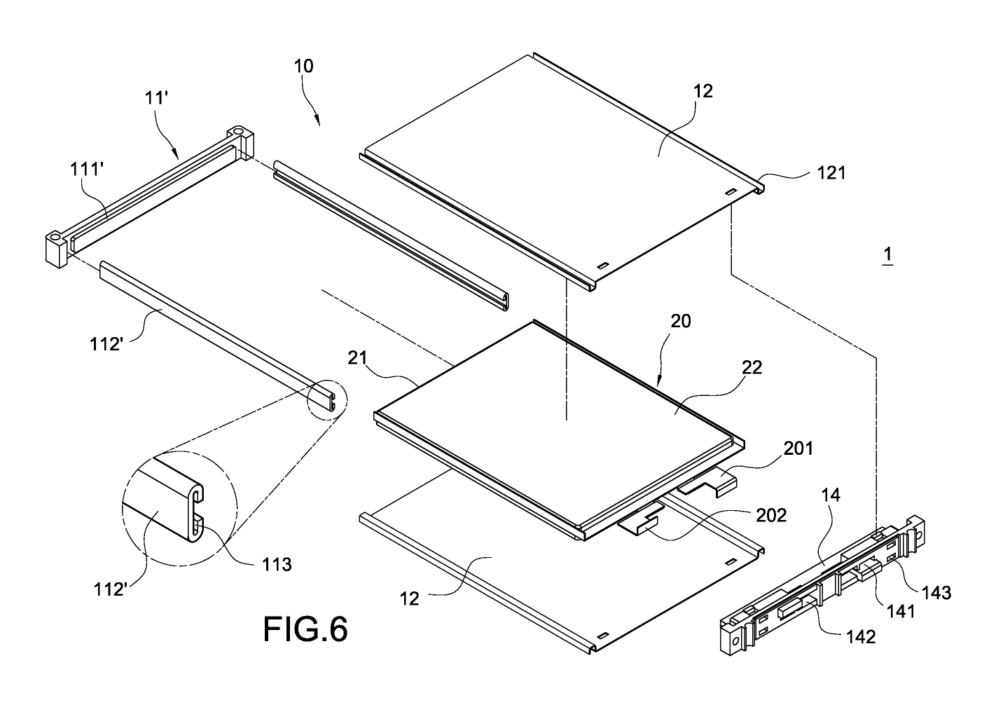

Please refer to FIG. 6, which is a secondary battery with enhanced structure according to the third embodiment of the invention. This embodiment is substantially the same as the first embodiment, except that the frame 11′ is comprised of separable bottom plate 111 and two lateral plates 112′ connected to the two lateral ends of the bottom plate 111′.

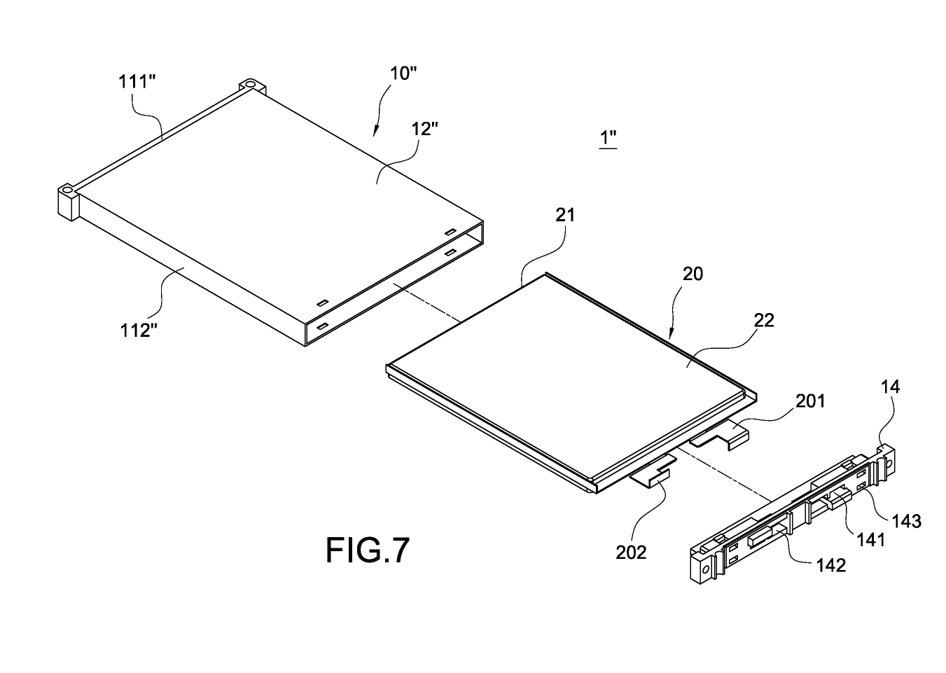

Please refer to FIG. 7, which is a secondary battery with enhanced structure according to the fourth embodiment of the invention. This embodiment is substantially the same as the first embodiment, except of the rigid shell 10″ of the secondary battery 1″. The rigid shell 10″ includes a bottom plate 111″, two lateral plates 112″ extended from the lateral ends of the bottom plate 111″, two panels 12″ and a top plate 14 closely sealing the bottom plate 111″, lateral plates 112″ and panels 12″, all of which are configured integrally.

Therefore, through the constitution of aforementioned assemblies, a secondary battery with enhanced structure according to the present invention is thus obtained.

Summarizing aforementioned description, the enhanced structure according to the present invention is an indispensable structure for secondary battery indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A secondary battery with enhanced structure, including:
a rigid shell, which has an accommodation space;
at least one flexible battery cell, which is arranged in the rigid shell; and
a sealing agent, which is injected into a gap between the flexible battery cell and the rigid shell.

2. The secondary battery with enhanced structure according to claim 1, wherein the rigid shell is made of a material of metal.

3. The secondary battery with enhanced structure according to claim 1, wherein the rigid shell includes a frame, two panels connected to two lateral sides of the frame and a top plate sealing and covering the frame and the two panels.

4. The secondary battery with enhanced structure according to claim 3, wherein the frame is of U shape and includes a bottom plate and two lateral plates extended from two lateral ends of the bottom plate.

5. The secondary battery with enhanced structure according to claim 4, wherein a cross section of the lateral plate is of C shape and configured two grooves.

6. The secondary battery with enhanced structure according to claim 5, wherein two lateral sides of the panel are respectively configured a connection part, a cross section of U shape, and which is inserted into the groove.

7. The secondary battery with enhanced structure according to claim 3, wherein the frame is assembled by a separable bottom plate and two lateral plates connected to two lateral ends of the bottom plate.

8. The secondary battery with enhanced structure according to claim 3, wherein the top plate has two slots, and the flexible battery cell has a positive terminal and a negative terminal, both of which are arranged by passing through the slots of the top plate.

9. The secondary battery with enhanced structure according to claim 3, wherein the top plate is arranged at least one injection hole, from which the sealing agent is injected into the rigid shell.

10. The secondary battery with enhanced structure according to claim 1, wherein the rigid shell includes a bottom plate, two lateral plates extended from two lateral ends of the bottom plate, two panels and a top plate closely sealing the bottom plate, the two lateral plates and the two panels, all of which are configured integrally.

11. The secondary battery with enhanced structure according to claim 1, wherein the flexible battery cell is a lithium-ion battery or a polymer lithium battery.

12. The secondary battery with enhanced structure according to claim 1, wherein the sealing agent is an epoxy.
